(19) United States
(12) Patent Application Publication
(10) Pub. No.: US 2024/0400370 A1
(43) Pub. Date: Dec. 5, 2024

(54) DISPENSER FOR DISPENSING FLUID

(71) Applicant: SHAH PLASTOTECH LLC, Palm Beach Gardens, FL (US)

(72) Inventors: Nirav Shah, Surat (IN); Shweta Shah, Surat (IN)

(21) Appl. No.: 18/622,257

(22) Filed: Mar. 29, 2024

(30) Foreign Application Priority Data
Apr. 1, 2023 (IN) 202321025074

(51) Int. Cl. B67D 7/18

(52) U.S. Cl. CPC B67D 7/18

(57) ABSTRACT

The present invention relates to a dispenser that includes an inlet pipe, a pumping sub-assembly, a cap and an actuator. The pumping sub-assembly includes a housing, a piston, a return mechanism of the type of bellow/compression spring/leaf spring, etc., a pusher which acts as a canal to transport the desired fluid/spirit/water/paste/cream/gel/foam, a valve made through a ball of predefined geometry placed on a seat and placed within a cage. One end of the housing includes the pipe and the other end includes the cap and actuator side. The pusher being attached to the actuator so that both move in relation to each other thereby completing the canal to the flow outside. The dispenser of the present invention is removably connectable to containers, for example, a bottle, such that the dispenser is recyclable in order to save the environment for the future generations.

### PRIORITY CLAIM

In accordance with 37 C.F.R. 1.76, a claim of priority is included in an Application Data Sheet filed concurrently herewith. Accordingly, the present invention claims the benefit of the priority of Indian Provisional Patent Application No. 202321025074, entitled “Dispenser for Dispending Fluid” filed Apr. 1, 2023; the contents of which are incorporated herein by reference.

### FIELD OF THE INVENTION

The present invention relates to dispensing devices and more particularly to dispenser device for dispensing a fluid from a container.

### BACKGROUND OF THE INVENTION

Dispenser pumps or positive-displacement pump are well known in the art that deliver a predetermined quantity of liquid. Any user of a dispenser pump wants the pump to deliver the precise amount of the liquid in a precise manner, and that too without any leakage. The dispenser pump includes fluid that is effectively moved inside various channels.

It is observed that the pumps in the art are either made of multiple materials of composites. Many of the pumps are made of multiple materials of plastic or a mix of metals, glass and plastic. As a result, there is a challenge of providing a structure in a manner where consistent flow will not be attained. Additionally, it is also not possible to regulate flow. Also, current versions of a few Full Plastic Pumps do not have a guaranteed mechanism of return.

One of the major challenges relating to dispensing pumps is the type of material of the dispensing pump and the type of the container. The dispensers of the prior art are generally of a mix of plastic material. Hence at the time of disposing the assembly of the pump and the container there has to be separate treatment to both of them. And it is extremely difficult to recycle the dispenser at all.

There is a need of a dispenser that addresses all the problems of the pumps in the prior art.

### SUMMARY OF THE INVENTION

The present invention relates to a dispenser that includes an inlet pipe, a pumping sub-assembly, a cap and an actuator. The pumping sub-assembly includes a housing, a piston, a return mechanism of the type of bellow/compression spring/leaf spring, etc., a pusher which acts as a canal to transport the desired fluid/spirit/water/paste/cream/gel/foam, a valve made through a ball of predefined geometry placed on a seat and placed within a cage. One end of the housing includes the pipe and the other end includes the cap and actuator side. The pusher being attached to the actuator so that both move in relation to each other thereby completing the canal to the flow outside. The dispenser of the present invention is removably connectable to containers, for example, a bottle, such that the dispenser is recyclable in order to save the environment for the future generations.

Accordingly, it is a primary objective of the instant invention is to provide a pump dispenser and pump assembly for dispensing a fluid from a container.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### DETAILED DESCRIPTION OF THE INVENTION

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed and obviously many modifications and variations are possible in light of the above teaching.

In general aspect the present invention discloses a dispenser that is removable mountable on a container for selectively dispensing fluid in the container without any leakage, but with a uniform discharge as and when required.

The present invention discloses a dispenser that includes an inlet pipe, a pumping sub-assembly, a cap and an actuator. The pumping sub-assembly includes a housing, a piston, a return mechanism type of bellow/compression spring/leaf spring, etc., a pusher which acts as a canal to transport the desired fluid/spirit/water/paste/cream/gel/foam, and a valve made through a ball of spherical/ovalish/parabolic geometry placed on a seat and placed within a cage.

The sub-assembly includes a closure or retainer piece that is positioned in such a way that the housing restricts the motion of the pusher coming out easily and it being restricted in a predefined zone. On one end the housing includes the pipe and on the other end includes the cap and actuator. The pusher being attached to the actuator so that both move in a relation to each other thereby completing the canal to the flow outside. The dispenser of the present invention is removably connectable to containers, for example, a bottle or like that such that the dispenser is recyclable in order to save the environment for the future generations.

In one embodiment, the sub-assembly has a piston integrated with the bellows in such a way that the bellows pushes back the piston and due to the inter-locking, the pusher and consequentially the actuator because of the positive attachment of the pusher and the actuator, thereby pushing the dispensing material inside the chamber for easy liftment and attaining zero positioning of the pump on its own self.

In another embodiment, the piston in the Pump sub-assembly is one way acting.

In another embodiment, the piston in the Pump is two way acting. In another embodiment, the return mechanism is either made of bellows or compression spring or leaf spring or helical spring.

In another embodiment, the piston in the sub-assembly is integrated with the bellows to form a single piece.

In another embodiment, the return mechanism is positioned above the piston.

In another embodiment, the return mechanism is placed below the piston.

In another embodiment, the closure/retainer of the pumping sub-assembly is made in a leak proof manner.

In another embodiment, the closure/retainer is designed in a way to act as a sealing gripper to make the entire sub-assembly leak proof.

In another embodiment, there is an O Ring Placed inside the sub-assembly to increase positive pressure and vacuum as well as reducing any scope of leakage.

In another embodiment, the Sub-assembly has a piston and pusher mechanism acting as a redundant two stage valve thereby ensuring leak proofing during airline operation.

In another embodiment the sub-assembly has a piston and pusher mechanism acting as a redundant multi stage valve thereby ensuring leak proofing during airline operation.

In another embodiment the sub-assembly has a piston and pusher mechanism acting as a moving valve thereby ensuring leak proofing during airline operation.

In another embodiment, the pusher and piston have an interlock thereby having a sliding cylindricity in concentric or co-axial direction by a flange and/or collar to make the product very seamless operational.

In another embodiment, the pusher closes down at a lock position and has a closed surface to surface locking just above the valve seat position in a way that the material cannot enter the chamber when locked in such a way so that the container can be used for any traveling, airline, transport, ecommerce, daily useful travel for the consumer as well as vacation travel, temperature difference travel, pressure difference travel as well,

In another embodiment, there is an additional return mechanism within the pump adding redundancy in the pump ensuring that there is no freezing of spring. In another embodiment, there is an additional return mechanism which may be bellows/leaf spring/helical spring/compression spring placed in a way that it pushes the actuator back to zero position of the pump.

In another embodiment, there is a flexible and collapsible mechanism between the pusher and the actuator. In another embodiment, there is a regulator to regulate the flow within the closure/retainer of the sub assembly. In another embodiment, such a regulator is placed as separate part within the retainer sub-assembly. In another embodiment there being windows to provide air exchange within the pump to ensure there is no vacuum created by negative pressure in the container.

In another embodiment, there being a cap and cap cover for functional purpose there by not allowing to open the cap and thereby the pump and bottle thereby protecting contamination, pilferage and unsolicited use of the pump. In another embodiment, the actuator is preferably supported by a return spring.

In another embodiment, the dispenser preferably includes a seal gripper from the outside of the cap preventing any leakage. In another embodiment, the locking mechanism for travel is so constructed that the actuator doesn't dispense fluid when being depressed by arranging a flexible link with the pusher in a way that the consumer can prevent messiness of the product in a way that there is a complete smooth operation.

In another embodiment, the mono material dispenser is made with a mechanism to dispense foam of a material by creating agitation during the flow of the fluid from pump sub-assembly to the actuator output. In another embodiment, the mono material dispenser is made with a mechanism and add-on features to create a mist of a fluid including but not limited to spirits, oils, aqueous solutions, medicated products.

In another embodiment, the mono material dispenser is made with a mechanism to dispense materials with a density similar to tooth pastes. In another embodiment, the mono material dispenser is made in order to dispense controlled droplet sizes between 2-10 microns of 80% droplets to deliver proper drugs to the lungs and other organs of the body to work well with all illness and still being disposable to save the environment.

In another embodiment, the mono material dispenser is made in order to dispense food grade materials like ketchups, sauces of varied kinds and creams and various cheese sauce like mayonnaise, spices, etc. In another embodiment, the mono material dispenser is made in order to dispense fluids/creams/spirits/gel in the range of 0.1-0.5 ml. In another embodiment, the mono material dispenser is made in order to dispense fluids/creams/spirits/gel in the range of 0.5-1.5 ml.

In another embodiment, the mono material dispenser is made in order to dispense fluids/creams/spirits/gel in the range of 1.5-3.5 ml. In another embodiment, the mono material dispenser is made in order to dispense fluids/creams/spirits/gel in the range of 3.5-5 ml. In another embodiment, the mono material dispenser is made to be airline safe. In another embodiment, the mono material dispenser is made to be ecommerce safe. In another embodiment, the mono material dispenser is made of recycled materials up to 25%. In another embodiment, the mono material dispenser is made of recycled materials up to 50%.

In another embodiment, the mono material dispenser is made of recycled materials up to 75%. In another embodiment, the mono material dispenser is made of recycled materials up to 100%. In one embodiment of the present invention, the dispenser includes a lock mechanism i.e. lock, leakage proof mechanism i.e. proofer, a one way piston, a guide integrated chamber and/or an airless mechanism. The chamber includes dispensing material. The redundant return mechanism of the dispenser of the present invention comes back to its original place after dispensing fluid thereby ensuring that none of the pump mechanism doesn't fail and it operates over long durability.

The dispenser of the present invention is operable in all environments including winter and summer, including high altitudes and zero altitude, northern hemisphere and southern hemisphere, rains and acute droughts, amid forests and latest civilizations. The dispenser may optionally include as a different part or modified existing regulator to adjust the flow mechanically as per requirement.

In accordance with the present invention, the dispenser is made of the same family of material as the bottles on which it is mounted. It is noted that when the dispenser and the bottle are advantageously crushed together for regrinding and recyclability. In one embodiment, the dispenser has a regulator to adjust the flow mechanically as per requirement.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A pump dispenser for dispensing a liquid from a container comprising:
an inlet pipe fluidly connected to a pumping sub-assembly, the pumping sub-assembly including a housing, a piston, and a return mechanism in the form of a spring, a cap portion displaceable to function as an actuator to displace a pusher which acts as a canal to transport the desired fluid, a valve ball placed on a seat and secured within a cage to limit displacement of the ball with respect to the seat.
